(19) United States
(12) Patent Application Publication
(10) Pub. No.: US 2024/0144127 A1
(43) Pub. Date: May 2, 2024

(54) METHOD AND SYSTEM FOR DYNAMIC ALLOCATION OF VEHICLES TO FLEETS

(71) Applicant: Argo AI, LLC, Pittsburgh, PA (US)

(72) Inventors: Sebastian Dovenor, Pittsburgh, PA (US); Shubhashree Venkatesh, Fremont, CA (US); Bennett Diaz, Austin, TX (US); Shenglong Gao, Sunnyvale, CA (US)

(21) Appl. No.: 18/051,629

(22) Filed: Nov. 1, 2022

(51) Int. Cl. G06Q 10/0631; G06Q 50/30

(52) U.S. Cl. CPC G06Q 10/06315; G06Q 50/30

(57) ABSTRACT

This document discloses system, method, and computer program product embodiments for dynamically assigning vehicles or other objects to fleets of multiple tenants. Each tenant will be assigned a primary fleet of objects (such as vehicles) and will be associated with a minimum service level requirement and parameters governing operation of each object that is assigned to that primary fleet. The system will maintain a common fleet of vehicles, from which objects may be temporarily assigned to the primary fleets. When one of the tenants submits a service request, the system will select an object from the common fleet, assign the selected object to the primary fleet of that tenant's primary fleet, and cause the object to fulfill the first trip request in accordance with the set of parameters governing operation of each object that is assigned to the primary fleet of that tenant.

### BACKGROUND

Services that operate, manage, and/or serve as dispatchers for multiple vehicles exist to support many applications. For example, a vehicle service provider may operate vehicles that pick up and deliver packages, that pick up and deliver restaurant orders, and/or that provide ride sharing or taxi services to human riders. In some cases, the vehicles that a single service provider manages may have multiple assigned purposes. The assigned purposes may vary from vehicle to vehicle, or even by time of day or tenant assignment for a single vehicle.

This document describes methods and systems that are directed to addressing the problems described above, and/or other issues.

### SUMMARY

At least some of the problems associated with the existing solutions will be shown solved by the subject matter of the independent claims that are included in this document. Additional advantageous aspects are discussed in the dependent claims. In various embodiments, this document describes a method of managing a group of objects such as vehicles to serve multiple partners. The method includes, for each of a plurality of partners, assigning a respective primary fleet of objects (such as vehicles) to that partner, in which each primary fleet comprises: (a) a service level requirement comprising a minimum number of objects that must be available for that primary fleet; and (b) a set of parameters governing operation of each object that is assigned to that primary fleet. The method also requires maintaining a common fleet of vehicles, from which vehicles or other objects may be temporarily assigned to one of the primary fleets.

When the system receives, from a first partner of the plurality of partners, a first task request (such as a trip request), then in response to the common fleet having a number of objects that equals or exceeds total unfulfilled service level requirements for all of the primary fleets, the system will select an object from the common fleet and assign the selected object to the primary fleet of the first partner. The system will then cause the selected object to fulfill the first task request in accordance with the set of parameters governing operation of each object that is assigned to the primary fleet of the first partner.

The methods described above may be embodied in a system including a processor and memory containing programming instructions that, when executed, will cause the processor to implement the actions described above. Various embodiments also include a computer program product that contains such programming instructions, and a memory containing the computer program product.

### BRIEF DESCRIPTION OF THE DRAWINGS

The accompanying drawings are incorporated into this document and form a part of the specification.

FIG. 1 illustrates a system architecture in accordance with aspects of the disclosure.

FIG. 2 illustrates a process of dynamically allocating objects from a common fleet to various tenant fleets.

FIG. 3 is an example illustration of certain steps of FIG. 2 in the context of vehicle fleets.

FIG. 4 is an example illustration of certain additional steps of FIG. 2 in the context of vehicle fleets.

FIG. 5 illustrates the concept of common fleet subgroups, in which each subgroup is associated with a class of tenants.

FIG. 6 is a flowchart illustrating how the system may resolve conflict between multiple, competing trip requests.

FIG. 7 is a block diagram that illustrates example subsystems of an autonomous vehicle.

FIG. 8 is an example computer system useful for implementing various embodiments of this disclosure.

### DETAILED DESCRIPTION

This document describes system, apparatus, device, method and/or computer program product embodiments, and/or combinations and sub-combinations of any of the above, for dynamically allocating fleets of vehicles to multiple tenants. The system is described by way of example using fleets of vehicles and ride service requests. However, the method and systems can be used, and are applicable, to allocate other types of task requests to vehicles, as well as task requests to other objects that may be assigned to a fleet. All such applications are intended to be included in this disclosure.

Current methods and systems for managing groups of vehicles are inefficient. For example, some services assign a dedicated fleet of vehicles to a single tenant for a given period of time. This static allocation can result in inefficient vehicle use, as some vehicles may remain idle during times that the tenant has a low usage requirement, and a dedicated fleet may not include enough vehicles to handle a tenant's requirements during periods of high demand. In addition, vehicles of a dedicated fleet may need to travel a relatively long distance when they switch from one assignment to another. This results in more energy usage, adds to traffic congestion, and increases vehicle wear and maintenance requirements.

As an alternative to static allocation of a dedicated fleet of vehicles to a single tenant, some services simply maintain a common, “universal” fleet of vehicles, in which all vehicles that service a given area are pooled and shared by multiple tenants. The universal fleet approach also has disadvantages. For example, it risks unintended sharing of information between tenants, as some data about a first tenant's trip (such as the drop-off location) may be exposed to a second tenant for whom the vehicle will perform its next assignment. This is in part because all vehicles share the same fleet, and authorizations for each vehicle are typically configured at the fleet level. It also can inhibit the fleet's ability to implement certain tenant-specific use cases, such as a tenant requirement that vehicles assigned to it not be operated in certain areas where competitors operate, or that a minimum number of vehicles be dedicated to the tenant's fleet at any given time.

This document describes methods and systems in which a service provider system dynamically allocates fleets of vehicles to various partners. The dynamic allocation methods described in this document can address the issues described above, as well as other issues.

As used in this document, the singular forms “a,” “an,” and “the” include plural references unless the context clearly dictates otherwise. Unless defined otherwise, all technical and scientific terms used in this document have the same meanings as commonly understood by one of ordinary skill in the art. As used in this document, the term “comprising” means “including, but not limited to.”

In this document, the term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones and the like. An “autonomous vehicle” (or “AV”) is a vehicle having a processor, programming instructions and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle's autonomous system and may take control of the vehicle.

While this document may describe various examples in the context of an AV, the present solution is not limited to AV applications. The present solution of dynamically allocating fleets of objects to tenants may be used in other applications, with fleets of objects such as robotic systems, manufacturing process equipment, or other items.

In this document, the terms “service provider system” and “service provider” refer to a system or entity that manages operation of a fleet of vehicles or other objects. The service provider system will include a memory, programming instructions, optional monitoring equipment such as GPS systems or other data, and communication equipment that enables the system to receive information from, and send instructions to, the vehicles or other objects that the system manages.

In this document the terms “tenant” and “partner” interchangeably refer to an entity that generates task requests for a group of objects (such as trip requests for vehicles) and sends the task requests to a service provider, and to whom a fleet may be assigned. For example, in the context of vehicles, a tenant may be a ride sharing service that submits trip requests for passengers, a grocery store or retailer that submits package pickup and delivery requests, or a subset of a larger entity such as a luggage transport service team of an airport operator.

In this document the term “fleet” refers to a finite, identifiable group of vehicles or other objects. For example, a fleet may be identified as those vehicles for whom a data set is maintained. The data set will include a vehicle identification number (VIN) or another unique identifier for each vehicle in the fleet.

Each fleet's data set may include or otherwise be associated with one or more vehicle configuration parameters that specify, limit, and/or regulate the operating behavior of vehicles that are assigned to the fleet. Configuration parameters may include, for example: (1) authorizations, and in particular which partners will receive telemetry data and other data (such as trip notifications) from the vehicles in the fleet; (2) geographical networking (GeoNet) instructions, such as lanes that vehicles in the fleet must follow when moving; and (3) map zones, such as boundaries within which a vehicle's operation is permitted or from which the vehicle's operation is restricted when assigned to the fleet, or boundaries that are associated with different operational parameter values (such as maximum speed or minimum following distance). Some configuration parameters may be time-dependent and/or cyclical, and therefore may vary based on factors such as: (a) traffic volume as received from a traffic service; (b) whether or not the time of the vehicle's trip is during a designated rush hour period; (c) anticipated demand increases at certain locations at certain times (such as the time that bars are scheduled to close, or the end time of a sporting or other entertainment event).

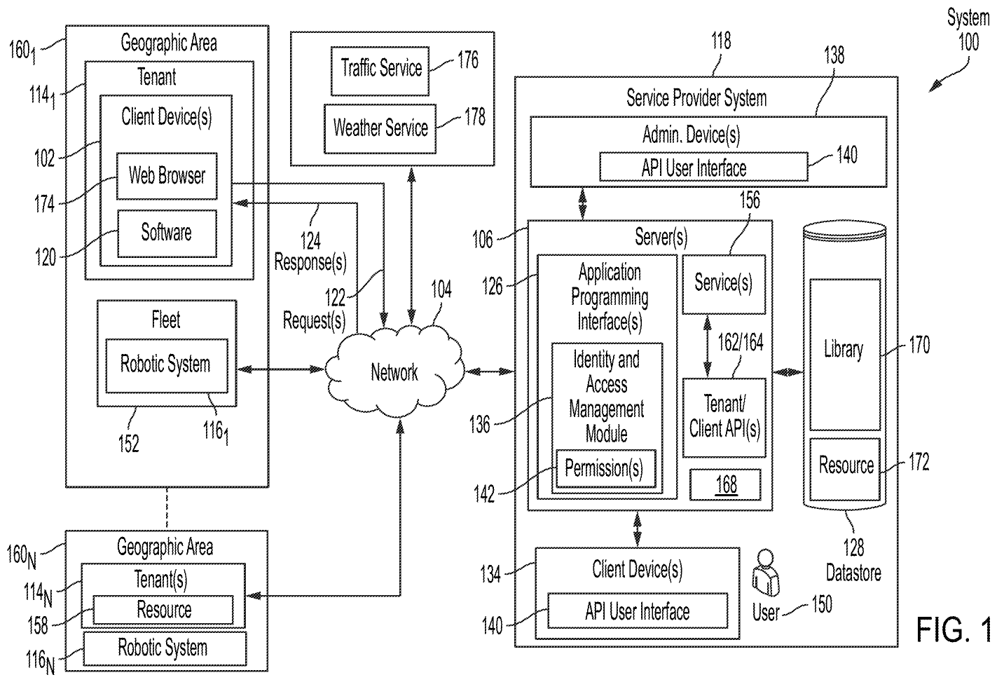

FIG. 1 illustrates an example system 100 for implementing the present solution. A service provider may use the system 100 to manage vehicles in various metropolitan or other geographic areas 160₁, . . . , 160_{N} for which multiple tenants will require use of the vehicles. Each tenant 114₁, . . . , 114_{N} can comprise or use tenant client device(s) 102 to submit trip requests for one or more assigned fleet(s) 152 of robotic systems 116₁, . . . , 116_{N} that are managed by the service provider. This access is facilitated by a web browser 174 and/or other software 120 installed on the tenant client device(s) 102. The robotic systems 116₁, . . . , 116_{N} can include, but are not limited to, land vehicles, aircraft, watercraft, subterrenes, spacecraft, drones, and/or even fixed devices with movable components (such as a robotic device with an articulating arm). Thus, by way of example, the service provider may be an operator of a fleet 152 of robotic systems that are autonomous vehicles, and tenants 114₁, . . . , 114_{N} (collectively referred to as tenants 114) may be delivery service operators, ride hailing service operators, or others who need access to the one or more vehicles of the fleet 152 at various times. The robotic systems 116₁, . . . , 116_{N} of the fleet 152 can be distributed across multiple geographic areas as shown, or they can be contained within a single metropolitan area as shown.

The tenant client device(s) 102 can be used by employees or other users of the tenants to send requests 122 for accessing services 156 supported by server(s) 106 of the service provider system 118 and/or for receiving responses 124 from the service provider system 118. The communications between tenant client device(s) 102 and services 156 can be facilitated via tenant application programming interfaces (APIs) 162. A separate tenant API can be provided for each tenant to allow for scalability for any number of tenants to be integrated into the system 100. In addition, one or more service provider client device(s) 134 can be used by employees or other users of the service to send requests 122 for accessing services 156 supported by server(s) 106 of the service provider system 118 and/or for receiving responses 124 from the service provider system 118.

The communications between service provider client device(s) 134 and services 156 can be facilitated via client API(s) 164. A separate client API can be provided for each client of the service provider to allow for scalability for any number service provider clients to be integrated into the system 100. The responses 124 can include, but are not limited to, resources generated by the server(s) 106 (for example, reports, data analytics, map data and/or other information) and/or resources 172 stored in a datastore 128 (for example, as map data, vehicle status information, and/or other information).

Various types of services 156 that may be provided by the service provider will be discussed in detail below. The services provided to client devices 102, 134 can include, for example, providing vehicles in response to ride service or delivery service requests, as well as providing current status and/or historical log information of all vehicle runs that the fleet performed or is performing for that tenant. In addition to service provider client devices 134, optionally the service provider system 118 may include one or more administrator client devices 138, which are service provider devices that are operated by individuals or systems having a higher level of authorization to perform functions that client devices operated by other users 150 may not be permitted to do (such as authorize client devices, as will be discussed below).

The service provider system 118 comprises an API 126 configured to facilitate assignment of permissions 142 and access management for the services 156. In this regard, API 126 comprises an identity and access management (IAM) module 136. IAM module 136 is configured to: (i) facilitate limitation and expansion of tenant permissions for requesting and/or accessing services and/or resources based on tenant identifiers, metropolitan identifiers and/or fleet identifiers; and (ii) ensure that IAM operations are consistent across all services 156.

Permissions can be assigned by an administrator using an administrator device 138 to each client device operated by a tenant 114 and/or each user 150 of a client device 134 of the service provider system 118. An API user interface 140 may be displayed on the administrator device 138 to facilitate the management of permissions 142 for tenants 114 and internal users 150. The permissions 142 are: fine grained enough to specify access down to the tenants, metropolitan area, fleets and/or users; flexible enough that a tenant 114₁ can be given permissions to a subset of resource(s) 158 of other tenant(s) 114_{N}; exposed in web authentication tokens to facilitate instant access by all services 156; and structured in a queryable format. The structure of the permissions will be discussed in detail below.

The service provider system 118 also may receive information from and/or send information to one or more external services via network 104. Example services include a traffic service 176 that supplies real-time, historic and/or predicted future traffic data and a weather service 178 that supplies real-time, historic and/or predicted future weather data for any of the geographic areas 160₁ . . . 160_{N}.

Various elements of the system described above may communicate with each other via one or more networks 104. Network 104 may include one or more wired or wireless networks. For example, the network 104 may include a cellular network (for example, a long-term evolution (LTE) network, a code division multiple access (CDMA) network, a 3G network, a 4G network, a 5G network, another type of next generation network, etc.). The network 104 may also include a public land mobile network (PLMN), a local area network (LAN), a wide area network (WAN), a metropolitan area network (MAN), a telephone network (for example, the Public Switched Telephone Network (PSTN)), a private network, an ad hoc network, an intranet, the Internet, a fiber optic-based network, a cloud computing network, and/or the like, and/or a combination of these or other types of networks.

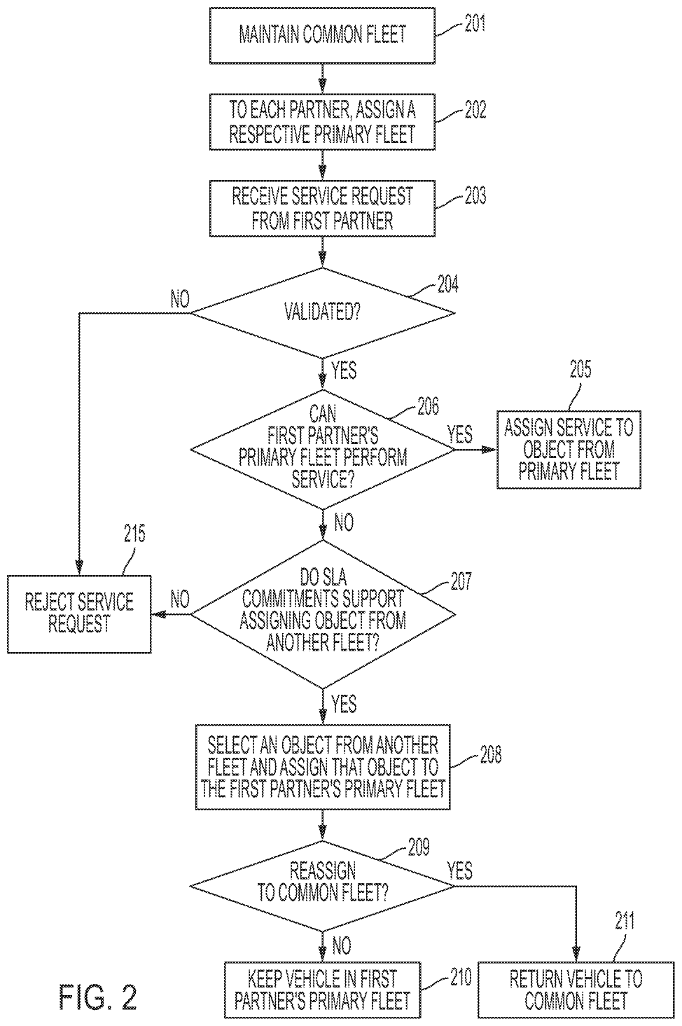

FIG. 2 is a flow diagram illustrating a method by which a service provider system, such as a vehicle dispatching system that manages a group of autonomous and/or human-operated vehicles, dynamically allocates fleets to multiple partners. FIG. 2 illustrates the method in the context of vehicles, but as noted above the process may be used to dynamically assign fleets of other objects to multiple partners. At 201 the system will maintain a fleet of vehicles, referred to in this document as a common fleet, that are not assigned to any particular partner's primary fleet. The common fleet is represented by a data set with vehicle identification codes (such as VIN numbers, license plate numbers, or other unique identifiers) for each vehicle in the common fleet. As will be described below, each partner will be associated with a service level requirement, which is a minimum number of vehicles that must be available for that partner at a given time. At the start of the process, before any vehicles are allocated to any partner, the number of vehicles in the common fleet will include at least, and optionally more than, the sum of all partners' service level requirement numbers.

At 202 the system will assign, to each of the partners, a respective primary fleet of vehicles. The assignment of a fleet to a partner generates or updates a data set that includes the vehicle identification codes for each vehicle in the partner's assigned fleet.

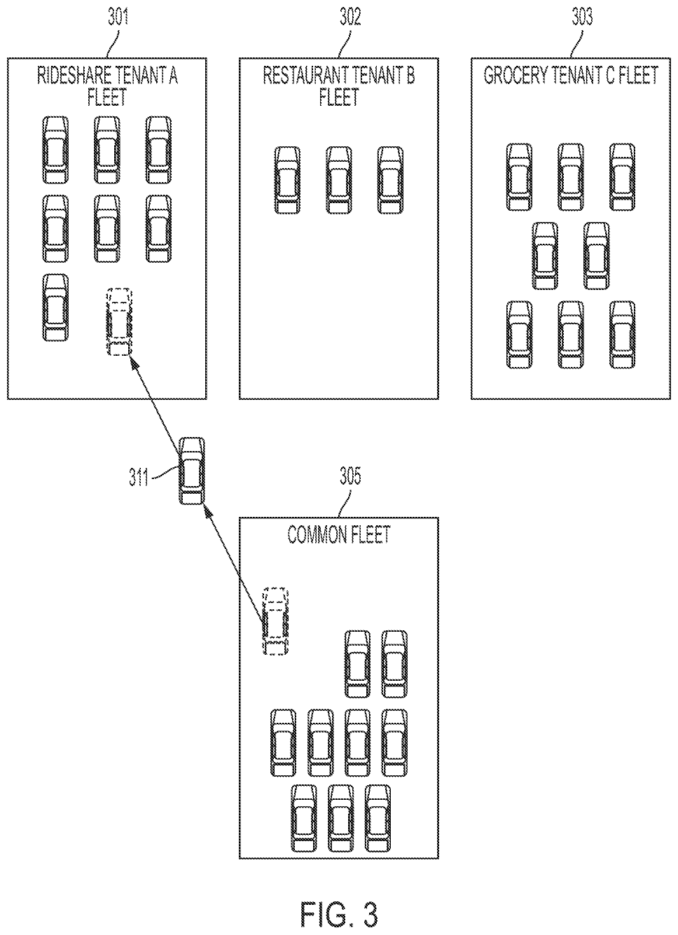

An example of this is shown in FIG. 3, which illustrates three example partners (tenants), in which a rideshare partner's (tenant A's) primary fleet 301 includes a first group of vehicles, a restaurant partner (tenant B's) primary fleet 302 includes a second group of vehicles, and a grocery partner's (tenant C's) primary fleet 303 includes a third group of vehicles. Note that FIG. 3 illustrates three different categories of partners with a single partner in each category, but in practice the system may work with multiple partners per category, or only one category with many partners, depending on the application.

Returning to FIG. 2, depending on the time of day or needs of a particular partner, the primary fleet assigned at 202 may include any number of vehicles, or even an empty set (i.e., no vehicles). By way of example, if a restaurant tenant's operating hours have not begun at the time of primary fleet allocation, the system may assign no vehicles to the restaurant tenant at that time. In some embodiments, all vehicles may begin in the common fleet, and all partner primary fleets may be empty until vehicles are assigned to the fleets in response to trip requests, as will be described below.

When assigning each primary fleet to a partner at 202, the system will associate each partner's primary fleet with, or store information indicating that each partner's primary fleet is associated with: (i) a service level requirement, which is a minimum number of vehicles that must be available for that partner at the time of allocation; and (ii) a set of parameters governing operation of each vehicle that is assigned to that partner's primary fleet. The system may maintain a database with this information, in which each partner's service level requirements and operational parameters are stored in the database. The number of vehicles assigned to a partner's primary fleet at 202 may be at least the minimum number of vehicles in the service level requirement. Alternatively, the number of vehicles initially assigned to a partner's primary fleet at 202 may be a smaller number, or even zero, so long as the system maintains a number of vehicles in the common fleet that is at least equal to the sum of the first partner's unfulfilled service level requirement plus the total of all partners' unfulfilled service level requirements.

This document may use the term “service level requirement,” “service level commitment,” “service level agreement,” or “SLA” for short, to refer to the number of vehicles that the service provider is required to be available for a partner's primary fleet. SLAs may vary for a given partner based on time of day, day of the week, and the like. For example, a partner may require a higher service level commitment during its business operating hours but no commitment when it is closed. The partner also may have higher SLA requirements at “peak” times corresponding to its typical busiest times, as compared to times when the partner typically is less busy. Also, in this document, the phrase “unfulfilled service level requirement” of a partner refers to a number of vehicles that the partner's service level requirement demands, but which are not yet specifically assigned to the first partner's primary fleet.

At 203 the system receives a service request (such as a trip request) from one of the partners. We will identify this partner as a “first partner” for purposes of this discussion. Optionally, as a first step at 204, the system may determine whether it can validate the request by examining the request to determine whether or not parameters of the request are consistent with certain identified conditions of service. For example, validation may require that the system confirm that: (i) the partner presents a proper authorization credential to the system; (ii) the service request includes for a starting point and ending point that are both within the system's map or other inventory of serviceable locations; (iii) the request will be completed within the fleet's designated operating hours; (iv) the service request does not exceed a capacity (number of passengers and/or weight or volume of goods) of available vehicles; and/or (v) one or more other conditions have been satisfied. If the request does not satisfy one or more of the validation conditions (204: NO), then the system may reject the request at 215.

If the request is valid, then optionally, if the first partner's primary fleet already has vehicles assigned to it, at 206 the system may determine whether any vehicle that is assigned the first partner's primary fleet can fulfill the request. If a vehicle in the first partner's primary fleet can fulfill the request (206: YES), then at 205 the system will transmit information to that vehicle that will cause the vehicle to fulfill the first trip request.

However, there may be many reasons why the first partner's primary fleet cannot fulfill the trip request. For example, if the first partner's primary fleet is empty at the time of the request, or if all of the first partner's primary fleet's vehicles are in service and will continue to serve other requests when the trip request is needed, then at 207 the system may determine whether it can assign a vehicle from the common fleet, or a vehicle from another partner's fleet, to the first partner's primary fleet.

The determination at 207 will depend on whether enough vehicles remain in the common fleet to satisfy all unfulfilled SLA commitments. If the number of vehicles remaining in the common fleet exceed unfulfilled SLA commitments, then the SLA commitments will support permit assigning vehicle from the common fleet (207: YES), and at 208 the system may assign a vehicle from the common fleet to the first partner's primary fleet, and it may assign the trip to the vehicle by transmitting information to that vehicle that will cause the vehicle to fulfill the first trip request. This is shown by way of example in FIG. 3, in which vehicle 311 is being reassigned from the common fleet 305 to the primary fleet of tenant A 301.

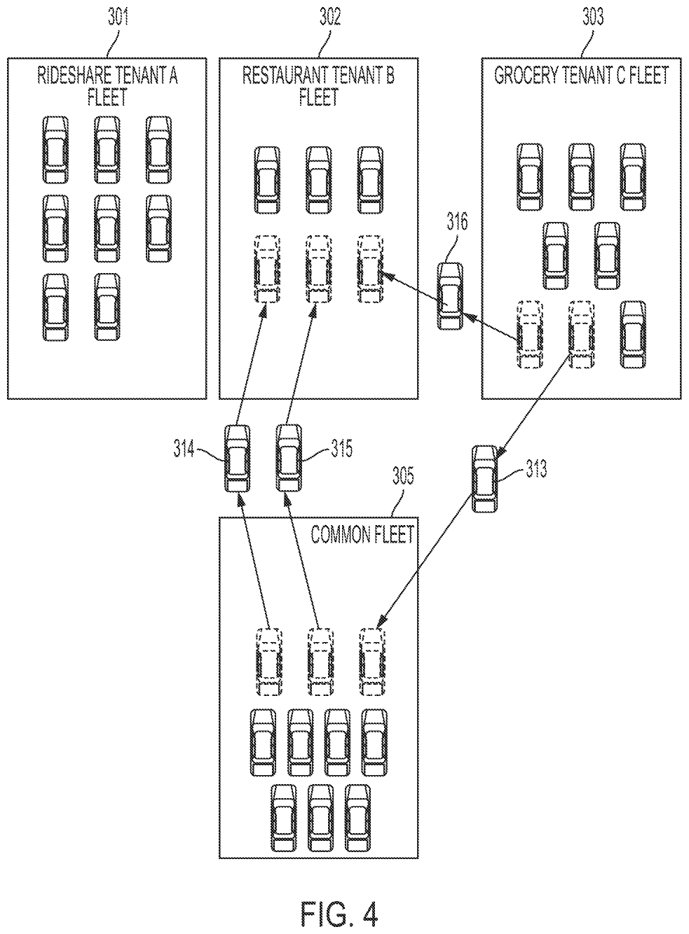

If at 207 the system determines that the number of vehicles remaining in the common fleet does not meet unfulfilled SLA commitments, but one or more other partner fleets has more vehicles allocated to it than that partner's SLA requires, then the SLA commitments will support assigning vehicle from the other partner's fleet (207: YES). Then, at 208 the system may assign a vehicle from the other partner's fleet to the first partner's primary fleet, and it may assign the trip to the vehicle by transmitting information to that vehicle that will cause the vehicle to fulfill the first trip request. This is also shown by way of example in FIG. 4, in which vehicle 316 is being reassigned from the primary fleet of tenant C 303 to the primary fleet of tenant B 302.

Returning to FIG. 2, if the number of vehicles available in the common fleet and/or other primary fleets does not permit assignment of a vehicle from the common fleet or another primary fleet to the first partner's primary fleet (207: NO), then the system may simply reject the service request at 215. Optionally, before rejecting the request, the system may wait some specified period of time for a vehicle from the first partner's primary fleet to become available. If a vehicle becomes available within the time period, it may assign the trip request to that vehicle at 205 when the vehicle becomes available. If the time period expires without a vehicle becoming available, the system will then reject the request at 215. Because the system starts with a common fleet with enough vehicles to satisfy all SLAs, this situation will only occur if either: (a) the number of vehicles already assigned to the first partner's fleet equals or exceeds the first partner's SLA; or (b) unexpected maintenance or other issues cause the number of vehicles in the common fleet to temporarily dip below the total number of required vehicles to fulfill all SLAs.

After the assigned vehicle completes the trip request, then at 209 the system may determine whether to remove the vehicle from the first partner's primary fleet and return it to the common fleet. The system may employ various factors and/or rules when making this decision. For example, if the number of vehicles in the first partner's primary fleet exceeds the SLA commitment to the first partner at the time, then at 211 the system may reassign the vehicle to the common fleet. This is illustrated by way of example in FIG. 4, in which vehicle 313 is being reassigned from tenant C's fleet 303 to the common fleet 305.

In some embodiments, the rules may require reassignment of each vehicle to the common fleet as soon as it fulfills a trip request (or, for other objects, as soon as it completes an assigned task). Otherwise, if the rules to do not require reassignment (209: NO), then at 210 the system may keep the vehicle in the primary fleet to which it is assigned until a rule triggers reassignment (209: YES).

Dynamic reallocation may occur in multiple directions, among multiple primary fleets in a concurrent manner. For example, FIG. 4 shows vehicle 313 being reassigned from tenant C's fleet 303 to the common fleet 305 at the same time that the system is assigning vehicles 314 and 315 from the common fleet 305 to tenant B's fleet 302.

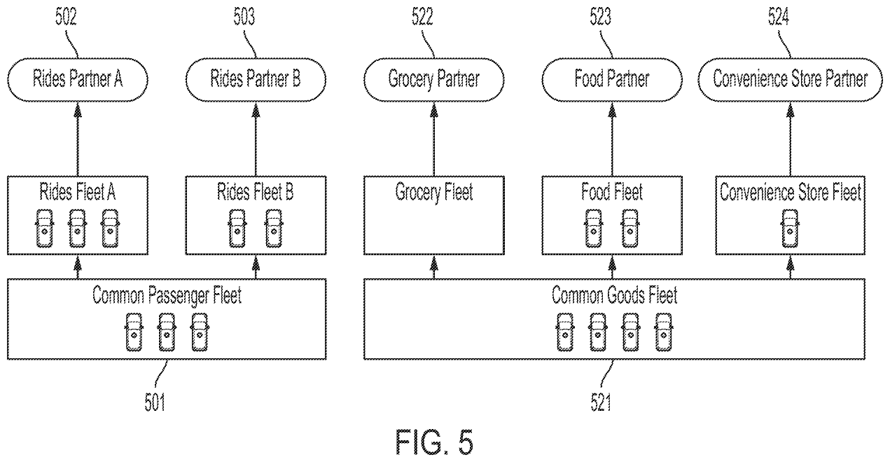

Some vehicles in a common fleet may not be appropriate for all applications. For example, vehicles that support ride sharing tenants may not be designed to support delivery of large packages. Similarly, package delivery trucks may not have sufficient passenger seating to support ride sharing services. Therefore, in some embodiments, the common fleet of vehicles may include various fleet subgroups, in which each fleet subgroup is associated with a class and includes vehicles that are designated to perform services for that class. This is illustrated by example in FIG. 5, in which the common fleet includes a common passenger fleet subgroup 501 and a common goods fleet subgroup 521. The vehicles in the common passenger fleet subgroup 501 may include sedans, sport-utility vehicles, passenger vans, buses, or other vehicles that include sufficient passenger seating and/or other features designed to transport passengers. The vehicles in the common passenger fleet subgroup 501 may be assigned to primary fleets of partners that submit trip requests, such as ride sharing partner A 502 and ride sharing partner B 503. The vehicles in the common goods fleet subgroup 521 may include trucks, delivery vans, or other vehicles that include package storage compartments or other features that are designed to transport goods. The vehicles in the common goods fleet subgroup 521 may be assigned to primary fleets of partners that submit trip requests such as grocery partner 522, food service partner 523, and convenience store partner 524. In embodiments that use common fleet subgroups, when selecting a vehicle from the common fleet for assignment to a partner's primary fleet, the system may select the vehicle from a subgroup that is associated with a class with which that partner is also associated.

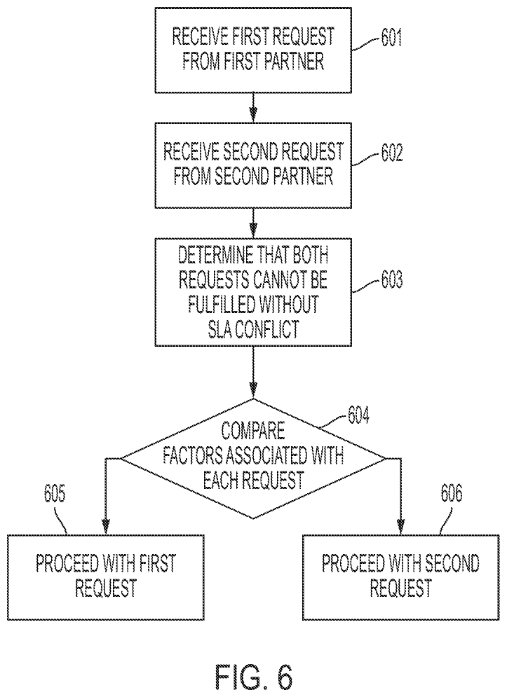

In operation, the service provider may need to handle multiple, competing trip requests from multiple partners. This can create conflict if the system can only fulfill one of the requests, but not both of them, without violating SLA commitments. For example, referring to FIG. 6, the system may receive a first service request (such as a trip request) from a first partner at 601, and the system also may receive a second service request from a second partner at 602 within a threshold time after receipt of the first service request. In response to identifying that the system cannot fulfill both requests without violating an SLA commitment (603), at 604 the system may compare one or more factors associated with the first service request with one or more corresponding factors associated with the second service request. Based on the results of the comparing, the system may give the first service request priority over the second service request and proceed to perform the service of the first request (605), or it may give the second service request priority over the first service request and proceed to perform the service of the second request (606).

The one or more factors compared at 604 may include one or more of the following:
(a) a time received, in which the first request received is given priority over the second request that is received, such that the system fulfills the first received request;
(b) a result of a randomization function, in which the system randomly selects one of the requests;
(c) a bid received from one or both partners, in which the request from the partner who bid the highest will be fulfilled;
(d) a calculation of a trip value per mile or total trip value, in which the trip request associated with the higher value per mile or higher overall value will be fulfilled;
(e) an assessment of a number of miles or an amount of time that the corresponding trip request will use in a current scheduled maintenance period for the selected vehicle, in which the system selects the trip request associated with either the relatively higher or the relatively lower number or amount;
(f) the existence of an edge case in one of the requests, in which case the system may either avoid the edge case or select the edge case, depending on whether or not the rules favor edge cases; or
(g) a destination that the selected vehicle will reach upon fulfillment of the corresponding trip request, in which the system may give preference to certain destinations (such as those near popular trip origination locations, or locations of hospitals or other urgent health care providers) over others.

Optionally, the system may permit a tenant to enter or otherwise provide data that, when considered in view of factors such as those listed above, will adjust the tenant's priority, whether on an assigned fleet basis or on a ride-specific basis. For example, some tenants may offer individual end users a premium pricing tier, or some tenants may generally pay for a premium level of service. In these situations, the tenant may offer a higher bid with a ride service request, which will result in that ride service request receiving a higher priority in the analysis of 604.

Various embodiments may include other variations of the processes described above. For example, the system may automatically identify or modify SLA requirements for a given partner at one or more periods of time. By way of example, if, over time, the system determines that a first partner submits requests at a frequency that is below a threshold (and that most or all other partners typically exceed the threshold), then the system may apply a minimum SLA to the first partner until the system has completed a number of service requests equal to the minimum SLA for that partner. This will help to ensure that vehicles or other objects are available for the first partner, even if other partners are more frequent users of the vehicles or other objects that the service manages.

In other embodiments, the system may move vehicles or other objects between fleets based on their geographic location. For example, if a vehicle assigned to a first tenant's primary fleet has a destination that is within the typical service area of a second tenant's primary fleet, upon completion of that vehicle's run the system may reassign that vehicle from the first tenant's fleet to the second tenant's fleet. (This is illustrated by way of example in FIG. 4 with the transfer of vehicle 316 from tenant C's fleet 303 to tenant B's fleet 302.) If the first tenant will need a vehicle in its primary fleet after completing the transfer, then the system may assign another vehicle from the common fleet to the first tenant's primary fleet, or it may exchange a vehicle from the second tenant's primary fleet into the first tenant's primary fleet.

In some embodiments, the system may dynamically alter SLAs for one or more partners or for categories of partners, based on one or more external factors. For example, if a large public event such as a sporting event, theater event, concert, or other activity is expected to attract a large group of attendees, and if the system receives notice of the event's expected end time, then the system may increase the minimum SLA for one or more partners who are associated with the ride sharing service category, in anticipation of ride sharing service partners receiving a relatively higher volume of trip requests at the event when the event ends.

In some embodiments, the system may assign fleets to one or more virtual or “phantom” partners. A virtual partner is not associated with a particular entity, but instead is a virtual entity to which the system assigns a fleet that will be used for other purposes. For example, the system may assign vehicles to virtual partners and fulfill virtual trip requests for those partners in which the trip requests end at certain specified destinations. In this way, the system may pre-position vehicles in certain geographic areas in anticipation of expected demand in or near those areas, such as in an area where a highly attended event is expected to end, as described above.

Referring again to FIG. 1, various embodiments of the system may generate and cause a client device 134 to provide a user interface via which a user 150 may enter or view data relating to a fleet. For example, the system may cause a client device 134 operated by a first tenant (such as tenant A in FIG. 3) to display a user interface by which the tenant can see information about that tenant's fleet 301. The information may include, for example, the locations of all vehicles assigned to the fleet, information about the active trip requests for each vehicle, how many vehicles remain idle in the fleet, and current configuration parameters for each vehicle. However, the system will not permit tenant A to view any information about vehicles that relate to operations of those vehicles while assigned to a different fleet (such as fleet 302 of tenant B). By maintaining the fleets separately, the system may move individual vehicles from one fleet to another, while only permitting each tenant to see vehicle information that relates to the time when the vehicle is actively assigned to that tenant's fleet.

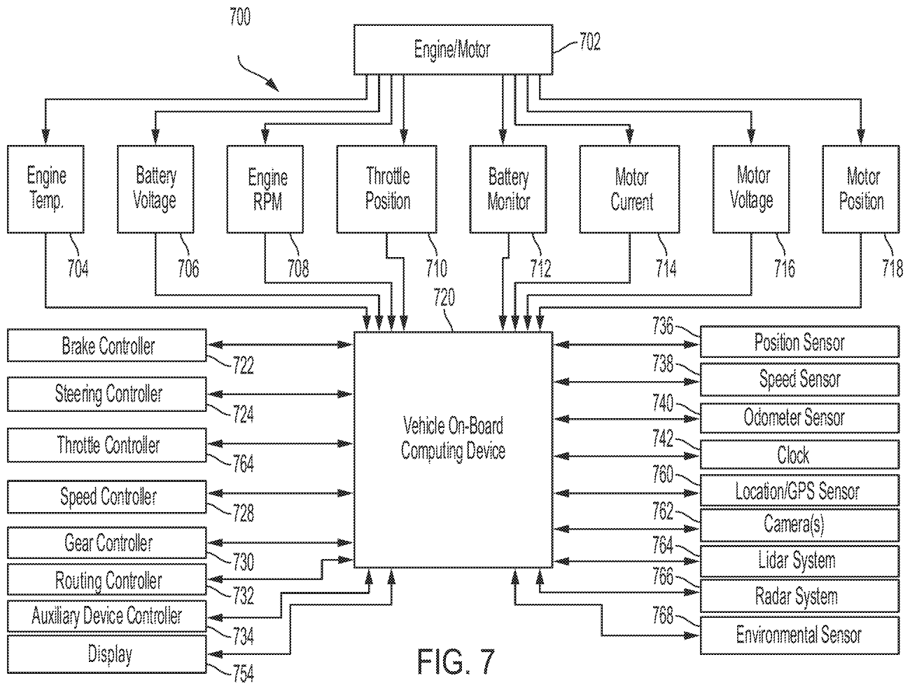

FIG. 7 illustrates an example system architecture 700 for a vehicle, in accordance with aspects of the disclosure. Robotic systems 116₁ . . . 116_{N} of FIG. 1 may have the same or similar system architecture as that shown in FIG. 7. However, other types of robotic systems are considered within the scope of the technology described in this document and may contain more or less elements as described in association with FIG. 7. As a non-limiting example, an airborne vehicle may exclude brake or gear controllers, but it may include an altitude sensor. In another non-limiting example, a water-based vehicle may include a depth sensor. One skilled in the art will appreciate that other propulsion systems, sensors, and controllers may be included based on a type of vehicle, as is known.

As shown in FIG. 7, system architecture 700 for a vehicle includes an engine or motor 702 and various sensors 704-718 for measuring various parameters of the vehicle. In gas-powered or hybrid vehicles having a fuel-powered engine, the sensors may include, for example, an engine temperature sensor 704, a battery voltage sensor 706, an engine revolutions per minute (“RPM”) sensor 708, and a throttle position sensor 710. If the vehicle is an electric or hybrid vehicle, then the vehicle may have an electric motor, and accordingly includes sensors such as a battery monitoring system 712 (to measure current, voltage and/or temperature of the battery), motor current 714 and voltage 716 sensors, and motor position sensors 718 such as resolvers and encoders.

Operational parameter sensors that are common to both types of vehicles include, for example: a position sensor 736 such as an accelerometer, gyroscope and/or inertial measurement unit; a speed sensor 738; and an odometer sensor 740. The vehicle also may have a clock 742 that the system uses to determine vehicle time during operation. The clock 742 may be encoded into the vehicle on-board computing device, it may be a separate device, or multiple clocks may be available.

The vehicle also may include various sensors that operate to gather information about the environment in which the vehicle is traveling. These sensors may include, for example: a location sensor 760 (such as a Global Positioning System (“GPS”) device); object detection sensors such as one or more cameras 762; and/or a lidar system 764; and/or a radar and/or sonar system 766. The sensors also may include environmental sensors 768 such as a precipitation sensor and/or ambient temperature sensor. The object detection sensors may enable the vehicle to detect objects that are within a given distance range of the vehicle in any direction, while the environmental sensors collect data about environmental conditions within the vehicle's area of travel.

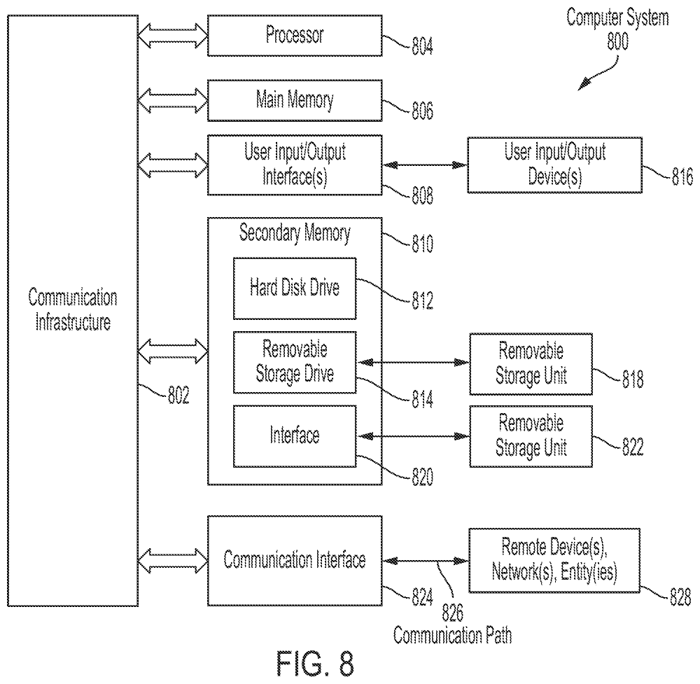

During operations, information is communicated from the sensors to a vehicle on-board computing device 720. The on-board computing device 720 may be implemented using the computer system of FIG. 8. The vehicle on-board computing device 720 analyzes the data captured by the sensors and optionally controls operations of the vehicle based on results of the analysis. For example, the vehicle on-board computing device 720 may control: braking via a brake controller 722; direction via a steering controller 724; speed and acceleration via a throttle controller 726 (in a gas-powered vehicle) or a motor speed controller 728 (such as a current level controller in an electric vehicle); a differential gear controller 730 (in vehicles with transmissions); and/or other controllers. Auxiliary device controller 734 may be configured to control one or more auxiliary devices, such as testing systems, auxiliary sensors, mobile devices transported by the vehicle, etc.

Geographic location information may be communicated from the location sensor 760 to the on-board computing device 720, which may then access a map of the environment that corresponds to the location information to determine known fixed features of the environment such as streets, buildings, stop signs and/or stop/go signals. Captured images from the cameras 762 and/or object detection information captured from sensors such as lidar system 764 is communicated from those sensors) to the on-board computing device 720. The object detection information and/or captured images are processed by the on-board computing device 720 to detect objects in proximity to the vehicle. Any known or to be known technique for making an object detection based on sensor data and/or captured images can be used in the embodiments disclosed in this document.

Lidar information is communicated from lidar system 764 to the on-board computing device 720. Additionally, captured images are communicated from the camera(s) 762 to the vehicle on-board computing device 720. The lidar information and/or captured images are processed by the vehicle on-board computing device 720 to detect objects in proximity to the vehicle. The manner in which the object detections are made by the vehicle on-board computing device 720 includes such capabilities detailed in this disclosure.

In addition, the system architecture 700 may include an onboard display device 754 that may generate and output an interface on which sensor data, vehicle status information, or outputs generated by the processes described in this document are displayed to an occupant of the vehicle. The display device may include, or a separate device may be, an audio speaker that presents such information in audio format.

The on-board computing device 720 may include and/or may be in communication with a routing controller 732 that generates a navigation route from a start position to a destination position for an autonomous vehicle. The routing controller 732 may access a map data store to identify possible routes and road segments that a vehicle can travel on to get from the start position to the destination position. The routing controller 732 may score the possible routes and identify a preferred route to reach the destination. For example, the routing controller 732 may generate a navigation route that minimizes Euclidean distance traveled or other cost function during the route, and it may further access the traffic information and/or estimates that can affect an amount of time it will take to travel on a particular route. Depending on implementation, the routing controller 732 may generate one or more routes using various routing methods, such as Dijkstra's algorithm, Bellman-Ford algorithm, or other algorithms. The routing controller 732 may also use the traffic information to generate a navigation route that reflects expected conditions of the route (e.g., current day of the week or current time of day, etc.), such that a route generated for travel during rush-hour may differ from a route generated for travel late at night. The routing controller 732 may also generate more than one navigation route to a destination and send more than one of these navigation routes to a user for selection by the user from among various possible routes.

In various embodiments, the on-board computing device 720 may determine perception information of the surrounding environment of the vehicle. Based on the sensor data provided by one or more sensors and location information that is obtained, the on-board computing device 720 may determine perception information of the surrounding environment of the vehicle. The perception information may represent what an ordinary driver would perceive in the surrounding environment of a vehicle. The perception data may include information relating to one or more objects in the environment of the vehicle. For example, the on-board computing device 720 may process sensor data (e.g., lidar or radar data, camera images, etc.) in order to identify objects and/or features in the environment of the vehicle. The objects may include traffic signals, roadway boundaries, other vehicles, pedestrians, and/or obstacles, etc. The on-board computing device 720 may use any now or hereafter known object recognition algorithms, video tracking algorithms, and computer vision algorithms (e.g., track objects frame-to-frame iteratively over a number of time periods) to determine the perception.

In some embodiments, the on-board computing device 720 may also determine, for one or more identified objects in the environment, the current state of the object. The state information may include, without limitation, for each object: current location; current speed and/or acceleration, current heading; current pose; current shape, size, or footprint; type (for example: vehicle, pedestrian, bicycle, static object or obstacle); and/or other state information.

The on-board computing device 720 may perform one or more prediction and/or forecasting operations. For example, the on-board computing device 720 may predict future locations, trajectories, and/or actions of one or more objects. For example, the on-board computing device 720 may predict the future locations, trajectories, and/or actions of the objects based at least in part on perception information (e.g., the state data for each object comprising an estimated shape and pose determined as discussed below), location information, sensor data, and/or any other data that describes the past and/or current state of the objects, the vehicle, the surrounding environment, and/or their relationship(s). For example, if an object is a vehicle and the current driving environment includes an intersection, the on-board computing device 720 may predict whether the object will likely move straight forward or make a turn. If the perception data indicates that the intersection has no traffic light, the on-board computing device 720 may also predict whether the vehicle may have to fully stop prior to entering the intersection.

In various embodiments, the on-board computing device 720 may determine a motion plan for the autonomous vehicle. For example, the on-board computing device 720 may determine a motion plan for the autonomous vehicle based on the perception data and/or the prediction data. Specifically, given predictions about the future locations of proximate objects and other perception data, the on-board computing device 720 can determine a motion plan for the vehicle that best navigates the autonomous vehicle relative to the objects at their future locations.

In some embodiments, the on-board computing device 720 may receive predictions and make a decision regarding how to handle objects and/or actors in the environment of the vehicle. For example, for a particular actor (e.g., a vehicle with a given speed, direction, turning angle, etc.), the on-board computing device 720 decides whether to overtake, yield, stop, and/or pass based on, for example, traffic conditions, map data, state of the autonomous vehicle, etc. Furthermore, the on-board computing device 720 also plans a path for the vehicle to travel on a given route, as well as driving parameters (e.g., distance, speed, and/or turning angle). That is, for a given object, the on-board computing device 720 decides what to do with the object and determines how to do it. For example, for a given object, the on-board computing device 720 may decide to pass the object and may determine whether to pass on the left side or right side of the object (including motion parameters such as speed). The on-board computing device 720 may also assess the risk of a collision between a detected object and the vehicle. If the risk exceeds an acceptable threshold, it may determine whether the collision can be avoided if the autonomous vehicle follows a defined vehicle trajectory and/or implements one or more dynamically generated emergency maneuvers is performed in a time period (e.g., N milliseconds). If the collision can be avoided, then the on-board computing device 720 may execute one or more control instructions to perform a cautious maneuver (e.g., mildly slow down, accelerate, change lane, or swerve). In contrast, if the collision cannot be avoided, then the on-board computing device 720 may execute one or more control instructions for execution of an emergency maneuver (e.g., brake and/or change direction of travel).

As discussed above, planning and control data regarding the movement of the autonomous vehicle is generated for execution. The on-board computing device 720 may, for example, control braking via a brake controller; direction via a steering controller; speed and acceleration via a throttle controller (in a gas-powered vehicle) or a motor speed controller (such as a current level controller in an electric vehicle); a differential gear controller (in vehicles with transmissions); and/or other controllers.

Various embodiments described above can be implemented, for example, using one or more computer systems, such as the server 106 of service provider system 118 shown in FIG. 1, or a client device 134 used by a tenant of the system or by an individual who submits a ride service request. As shown in FIG. 8, computer system 800 can be any computer capable of performing the functions described in this document.

Computer system 800 includes one or more processors (also called central processing units, or CPUs), such as a processor 804. Processor 804 is connected to a communication infrastructure or bus 802. Optionally, one or more of the processors 804 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 also includes user input/output device(s) 816, such as monitors, keyboards, pointing devices, etc., that communicate with communication infrastructure 802 through user input/output interface(s) 808.

Computer system 800 also includes a main or primary memory 806, such as random access memory (RAM). Main memory 806 may include one or more levels of cache. Main memory 806 has stored therein control logic (i.e., computer software) and/or data.

Computer system 800 may also include one or more secondary storage devices or memory 810. Secondary memory 810 may include, for example, a hard disk drive 812 and/or a removable storage device or drive 814. Removable storage drive 814 may be an external hard drive, a universal serial bus (USB) drive, a memory card such as a compact flash card or secure digital memory, a floppy disk drive, a magnetic tape drive, a compact disc drive, an optical storage device, a tape backup device, and/or any other storage device/drive.

Removable storage drive 814 may interact with a removable storage unit 818. Removable storage unit 818 includes a computer usable or readable storage device having stored thereon computer software (control logic) and/or data. Removable storage unit 818 may be an external hard drive, a universal serial bus (USB) drive, a memory card such as a compact flash card or secure digital memory, a floppy disk, a magnetic tape, a compact disc, a DVD, an optical storage disk, and/any other computer data storage device. Removable storage drive 814 reads from and/or writes to removable storage unit 818 in a well-known manner.

According to an example embodiment, secondary memory 810 may include other means, instrumentalities or other approaches for allowing computer programs and/or other instructions and/or data to be accessed by computer system 800. Such means, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 enables computer system 800 to communicate and interact with any combination of remote devices, remote networks, remote entities, etc. (individually and collectively referenced by reference number 828). For example, communication interface 824 may allow computer system 800 to communicate with remote devices 828 over communications path 826, which may be wired and/or wireless, and which may include any combination of LANs, WANs, the Internet, etc. Control logic and/or data may be transmitted to and from computer system 800 via communication path 826.

In some embodiments, a tangible, non-transitory apparatus or article of manufacture comprising a tangible, non-transitory computer useable or readable medium having control logic (software) stored thereon is also referred to in this document as a computer program product or program storage device. This includes, but is not limited to, computer system 800, main memory 806, secondary memory 810, and removable storage units 818 and 822, as well as tangible articles of manufacture embodying any combination of the foregoing. Such control logic, when executed by one or more data processing devices (such as computer system 800), causes such data processing devices to operate as described in this document.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described in this document.

Terms that are relevant to this disclosure include:

An “electronic device” or a “computing device” refers to a device that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions.

The terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices. A computer program product is a memory device with programming instructions stored on it.

The terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices, which may be components of a single device or components of separate devices, together or collectively perform a process.

The term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones and the like. An “autonomous vehicle” (or “AV”) is a vehicle having a processor, programming instructions and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle's autonomous system and may take control of the vehicle.

A “run” of a vehicle refers to an act of operating a vehicle and causing the vehicle to move about the real world. A run may occur in public, uncontrolled environments such as city or suburban streets, highways, or open roads. A run may also occur in a controlled environment such as a test track.

In this document, the terms “communication link” and “communication path” mean a wired or wireless path via which a first device sends communication signals to and/or receives communication signals from one or more other devices. Devices are “communicatively connected” if the devices are able to send and/or receive data via a communication link. “Electronic communication” refers to the transmission of data via one or more signals between two or more electronic devices, whether through a wired or wireless network, and whether directly or indirectly via one or more intermediary devices. The term “wireless communication” refers to communication between two devices in which at least a portion of the communication path includes a signal that is transmitted wirelessly, but it does not necessarily require that the entire communication path be wireless.

In this document, the terms “street,” “lane,” “road” and “intersection” are illustrated by way of example with vehicles traveling on one or more roads. However, the embodiments are intended to include lanes and intersections in other locations, such as parking areas. In addition, for autonomous vehicles that are designed to be used indoors (such as automated picking devices in warehouses), a street may be a corridor of the warehouse and a lane may be a portion of the corridor. If the autonomous vehicle is a drone or other aircraft, the term “street” or “road” may represent an airway and a lane may be a portion of the airway. If the autonomous vehicle is a watercraft, then the term “street” or “road” may represent a waterway and a lane may be a portion of the waterway.

In this document, when terms such as “first” and “second” are used to modify a noun, such use is simply intended to distinguish one item from another, and is not intended to require a sequential order unless specifically stated. In addition, terms of relative position such as “vertical” and “horizontal”, or “front” and “rear”, when used, are intended to be relative to each other and need not be absolute, and only refer to one possible position of the device associated with those terms depending on the device's orientation.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes example embodiments for example fields and applications, it should be understood that the disclosure is not limited to the disclosed examples. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described in this document. Further, embodiments (whether or not explicitly described) have significant utility to fields and applications beyond the examples described in this document.

Embodiments have been described in this document with the aid of functional building blocks illustrating the implementation of specified functions and relationships. The boundaries of these functional building blocks have been arbitrarily defined in this document for the convenience of the description. Alternate boundaries can be defined as long as the specified functions and relationships (or their equivalents) are appropriately performed. Also, alternative embodiments can perform functional blocks, steps, operations, methods, etc. using orderings different than those described in in this document.

The features from different embodiments disclosed herein may be freely combined. For example, one or more features from a method embodiment may be combined with any of the system or product embodiments. Similarly, features from a system or product embodiment may be combined with any of the method embodiments herein disclosed.

References in this document to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described in this document.

The breadth and scope of this disclosure should not be limited by any of the above-described example embodiments, but should be defined only in accordance with the following claims and their equivalents.

As described above, this document discloses system, method, and computer program product embodiments for managing groups of vehicles. The system embodiments include a processor and a memory with programming instructions. The computer program embodiments include programming instructions, e.g., stored in a memory, to cause a processor to perform the data management methods described in this document. The system embodiments also include a processor which is configured to perform the methods described in this document, e.g., via the programming instructions. More generally, the system embodiments include a system comprising means to perform the steps of the any of the methods described in this document.

Without excluding further possible embodiments, certain example embodiments are summarized in the following clauses:
Clause 1. [copy claim 1]: A computer-implemented method of managing a group of objects such as vehicles to serve multiple partners. The method includes, for each of a plurality of partners, assigning a respective primary fleet of objects (such as vehicles) to that partner, in which each primary fleet comprises: (a) a service level requirement comprising a minimum number of objects that must be available for that primary fleet; and (b) a set of parameters governing operation of each object that is assigned to that primary fleet. The method also requires maintaining a common fleet of vehicles, from which objects may be temporarily assigned to one of the primary fleets. When the system receives (in response to receiving) a first task request (such as a trip request) from a first partner of the plurality of partners, then also in response to the common fleet having a number of objects that equals or exceeds total unfulfilled service level requirements for all of the primary fleets, the system will select an object from the common fleet and assign the selected object to the primary fleet of the first partner. The system will then cause the selected object to fulfill the first task request in accordance with the set of parameters governing operation of each object that is assigned to the primary fleet of the first partner.
Clause 2. The method of clause 1, wherein selecting the object from the common fleet and assigning the selected object to the primary fleet of the first partner is also in response to the primary fleet of the first partner not having an object available to fulfill the first task request.
Clause 3. The method of clause 1 further comprising, after fulfillment of the first task request: in response to exceeding of the service level requirement for the first partner, re-assigning the selected object to the common fleet.
Clause 4. The method of clause 1 further comprising, after fulfillment of the first task request, re-assigning the selected object to the common fleet.
Clause 5. The method of clause 1 further comprising, when assigning the respective partner primary fleet to at least one of the partners, assigning an empty set of objects to that partner primary fleet until an object from the common fleet is dynamically allocated to that primary fleet.
Clause 6. The method of clause 1, wherein: (a) the common fleet of objects comprises a plurality of fleet subgroups, in which each fleet subgroup is associated with a class and comprises a plurality of objects that are designated to performing services for that class; and (b) the method further comprises, when selecting the object from the common fleet, selecting the object from a subgroup that is associated with a class with which the first partner is also associated.
Clause 7. The method of clause 1, wherein the service level requirement for at least one of the partners dynamically changes based on at least one of the following: time of day; traffic conditions; or anticipated ending of a public event.
Clause 8. The method of clause 1 further comprising: (a) receiving a second task request (such as a second trip request) from a second partner of the plurality of partners; (b) in response to receiving the second task request within a threshold time after receipt of the first trip request: (i) comparing one or more factors associated with the first trip request with one or more corresponding factors associated with the second task request, and (ii) based on the comparing, giving the first task request priority over the second task request. In this cause, assigning the selected object to the primary fleet of the first partner is also in response to the first task request being given priority over the second task request.
Clause 9. The method of clause 8, wherein the one or more factors for each of the first task request and the second task request comprise one or more of the following: a result of a randomization function; a bid received from the partner who submitted the corresponding trip request; an assessment of a number of miles or an amount of time that the corresponding trip request will use in a current scheduled maintenance period for the selected vehicle; the existence of an edge case in one of the trip requests; or a destination of that the selected vehicle upon fulfillment of the corresponding trip request.
Clause 10. The method of clause 1, wherein at least one of the partners is a virtual partner, and the set of parameters governing operation of each object that is assigned to the primary fleet of the virtual partner comprises a geographic location of a destination of the first task request.
Clause 11. The method of clause 1, further comprising causing an electronic device of the first partner to output a user interface that displays information about a group of objects that are assigned to the primary fleet of the first partner, but which does not provide the first partner access to any information about any objects in the group that relates to time periods when those objects were assigned to the primary fleet of a different partner.
Clause 12. The method of clause 1 further comprising, prior to selecting the object from the common fleet and assigning the selected object to the primary fleet of the first partner, validating the first task request by confirming that parameters of the request are consistent with identified conditions of service.
Clause 14. A fleet allocation system comprising a processor, along with a memory having programming instructions that are configured to cause the processor to perform the steps of any of the above method clauses.
Clause 15. A system comprising means for performing steps of any of the above method clauses.
Clause 16. A computer program, or a storage medium storing the computer program, comprising instructions, which when executed by one or more suitable processors cause any of the processors to perform the steps of any of the above method clauses.

1. A method of managing a group of vehicles to serve multiple partners, the method comprising:
for each of a plurality of partners, assigning a respective primary fleet of vehicles to that partner, in which each primary fleet comprises:
a service level requirement comprising a minimum number of vehicles that must be available for that primary fleet, and
a set of parameters governing operation of each vehicle that is assigned to that primary fleet;
maintaining a common fleet of vehicles, from which vehicles may be temporarily assigned to one of the primary fleets;
receiving, from a first partner of the plurality of partners, a first trip request;
in response to the common fleet having a number of vehicles that equals or exceeds total unfulfilled service level requirements for all of the primary fleets, selecting a vehicle from the common fleet and assigning the selected vehicle to the primary fleet of the first partner; and
causing the selected vehicle to fulfill the first trip request in accordance with the set of parameters governing operation of each vehicle that is assigned to the primary fleet of the first partner.

2. The method of claim 1, wherein selecting the vehicle from the common fleet and assigning the selected vehicle to the primary fleet of the first partner is also in response to the primary fleet of the first partner not having a vehicle available to fulfill the first trip request.

3. The method of claim 1 further comprising, after fulfillment of the first trip request:
in response to exceeding of the service level requirement for the first partner, re-assigning the selected vehicle to the common fleet.

4. The method of claim 1 further comprising, after fulfillment of the first trip request, re-assigning the selected vehicle to the common fleet.

5. The method of claim 1 further comprising, when assigning the respective partner primary fleet to at least one of the partners, assigning an empty set of vehicles to that partner primary fleet until a vehicle from the common fleet is dynamically allocated to that primary fleet.

6. The method of claim 1, wherein:
the common fleet of vehicles comprises a plurality of fleet subgroups, in which each fleet subgroup is associated with a class and comprises a plurality of vehicles that are designated to performing services for that class; and
the method further comprises, when selecting the vehicle from the common fleet, selecting the vehicle from a subgroup that is associated with a class with which the first partner is also associated.

7. The method of claim 1, wherein the service level requirement for at least one of the partners dynamically changes based on at least one of the following: time of day; traffic conditions; or anticipated ending of a public event.

8. The method of claim 1 further comprising:
receiving a second trip request from a second partner of the plurality of partners;
in response to receiving the second trip request within a threshold time after receipt of the first trip request:
comparing one or more factors associated with the first trip request with one or more corresponding factors associated with the second trip request, and
based on the comparing, giving the first trip request priority over the second trip request; and
wherein assigning the selected vehicle to the primary fleet of the first partner is also in response to the first trip request being given priority over the second trip request.

9. The method of claim 8, wherein the one or more factors for each of the first trip request and the second trip request comprise one or more of the following:
a result of a randomization function;
a bid received from the partner who submitted the corresponding trip request;
an assessment of a number of miles or an amount of time that the corresponding trip request will use in a current scheduled maintenance period for the selected vehicle;
the existence of an edge case in one of the trip requests; or
a destination of that the selected vehicle upon fulfillment of the corresponding trip request.

10. The method of claim 1, wherein at least one of the partners is a virtual partner, and the set of parameters governing operation of each vehicle that is assigned to the primary fleet of the virtual partner comprises a geographic location of a destination of the first trip request.

11. The method of claim 1, further comprising causing an electronic device of the first partner to output a user interface that displays information about a group of vehicles that are assigned to the primary fleet of the first partner, but which does not provide the first partner access to any information about any vehicles in the group that relates to time periods when those vehicles were assigned to the primary fleet of a different partner.

12. The method of claim 1 further comprising, prior to selecting the vehicle from the common fleet and assigning the selected vehicle to the primary fleet of the first partner:
validating the first trip request by confirming that parameters of the request are consistent with identified conditions of service.

13. A fleet allocation system comprising:
a processing device; and
a memory containing programming instructions that are configured to, when executed by the processing device, cause the processing device to manage a group of vehicles to serve multiple partners by:
for each of a plurality of partners, assigning a respective primary fleet of vehicles to that partner, in which each primary fleet comprises:
a service level requirement comprising a minimum number of vehicles that must be available for that primary fleet, and
a set of parameters governing operation of each vehicle that is assigned to that primary fleet;
maintaining a common fleet from which vehicles may be temporarily assigned to one of the primary fleets;
in response to (i) receiving a first trip request from a first partner of the plurality of partners and (ii) the common fleet having a number of vehicles that equals or exceeds total unfulfilled service level requirements for all of the primary fleets, selecting a vehicle from the common fleet and assigning the selected vehicle to the primary fleet of the first partner; and
causing the selected vehicle to fulfill the first trip request in accordance with the set of parameters governing operation of each vehicle that is assigned to the primary fleet of the first partner.

14. The system of claim 13, wherein the instructions to select the vehicle from the common fleet and assign the selected vehicle to the primary fleet of the first partner comprise instructions to do so also in response to the primary fleet of the first partner not having a vehicle available to fulfill the first trip request.

15. The system of claim 13 further comprising instructions to, after fulfillment of the first trip request, re-assign the selected vehicle to the common fleet.

16. The system of claim 13, wherein the instructions to assign the respective partner primary fleet to at least one of the partners, comprise instructions to assign an empty set of vehicles to that partner primary fleet until a vehicle from the common fleet is dynamically allocated to that primary fleet.

17. The system of claim 13, wherein:
the common fleet of vehicles comprises a plurality of fleet subgroups, in which each fleet subgroup is associated with a class and comprises a plurality of vehicles that are designated to performing services for that class; and
the system further comprises additional instructions to, when selecting the vehicle from the common fleet, select the vehicle from a subgroup that is associated with a class with which the first partner is also associated.

18. The system of claim 13 further comprising additional instructions to, in response to receiving a second trip request from a second partner of the plurality of partners within a threshold time after receipt of the first trip request:
compare one or more factors associated with the first trip request with one or more corresponding factors associated with the second trip request;
based on the comparing, giving the first trip request priority over the second trip request; and
when assigning the selected vehicle to the primary fleet of the first partner, doing so also in response to the first trip request being given priority over the second trip request.

19. The system of claim 13, further comprising additional programming instructions that are configured to cause an electronic device of the first partner to output a user interface that displays information about a group of vehicles that are assigned to the primary fleet of the first partner, but which does not provide the first partner access to any information about any vehicles in the group for time periods when those vehicles were assigned to the primary fleet of a different partner.

20. A computer program product comprising a memory containing programming instructions that are configured to, when executed by a processing device, will cause the processing device to manage a fleet to serve multiple partners by:
for each of a plurality of partners, assigning a respective primary fleet of objects to that partner, in which each primary fleet comprises:
a service level requirement comprising a minimum number of objects that must be available for that primary fleet, and
a set of parameters governing operation of each object that is assigned to that primary fleet;
maintaining a common fleet from which objects may be temporarily assigned to one of the primary fleets;
in response to (i) receiving a task request from a first partner of the plurality of partners and (ii) the common fleet having a number of objects that equals or exceeds total unfulfilled service level requirements for all of the primary fleets, selecting an object from the common fleet and assigning the selected object to the primary fleet of the first partner; and
causing the selected object to fulfill the task request in accordance with the set of parameters governing operation of each object that is assigned to the primary fleet of the first partner.
